(19) United States
(12) Patent Application Publication
(10) Pub. No.: US 2018/0004101 A1
(43) Pub. Date: Jan. 4, 2018

(54) SINGLE-LAYER TYPE ELECTROPHOTOGRAPHIC PHOTORECEPTOR FOR POSITIVE CHARGING, ELECTROPHOTOGRAPHIC PHOTORECEPTOR CARTRIDGE, AND IMAGE FORMING APPARATUS

(71) Applicant: Mitsubishi Chemical Corporation, Tokyo (JP)

(72) Inventors: Mitsuo WADA, Kanagawa (JP); Hiroe FUCHIGAMI, Kanagawa (JP); Akira ANDO, Kanagawa (JP)

(73) Assignee: Mitsubishi Chemical Corporation, Tokyo (JP)

(21) Appl. No.: 15/702,494

(22) Filed: Sep. 12, 2017

Related U.S. Application Data
(63) Continuation of application No. PCT/JP2016/057676, filed on Mar. 10, 2016.

(30) Foreign Application Priority Data
Mar. 13, 2015 (JP) 2015-050946

(51) Int. Cl. G03G 5/06; G03G 5/05; G03G 15/00

(52) U.S. Cl. CPC G03G 5/0609; G03G 15/75; G03G 5/0564; G03G 5/0696

(57) ABSTRACT

The present invention relates to a single-layer type electrophotographic photoreceptor for positive charging, comprising: a conductive support; and a photosensitive layer disposed on the conductive support and comprising a binder resin, a charge generation material, a hole transport material and a specific electron transport material within the same layer, wherein the photosensitive layer contains a specific aromatic compound.

### TECHNICAL FIELD

Electrophotography has been widely used in the field of copiers and in the field of various printers, because of the advantages such as instantaneousness, the ability to produce high-quality images, and the like. Regarding electrophotographic photoreceptors (hereinafter, simply also referred to as “photoreceptor”), which are the core of electrophotography, photoreceptors employing, as the photoconductive substance thereof, an organic photoconductive substance having advantages such as non-pollution, ease of film formation, and ease of production has been used in recent years.

Regarding an organic electrophotographic photoreceptors, a so-called function allocation type photoreceptor, in which different compounds are separately in charge of charge generation and charge transport, can be made of various materials and has easily controllable photoreceptor properties. This has made the development of such function-allocation type photoreceptor the mainstream of the photoreceptor development. In terms of layer constitution, as known photoreceptors, there exist a single-layer type electrophotographic photoreceptor (hereinafter, referred to as “single-layer type photoreceptor”) and a multilayer type electrophotographic photoreceptor (hereinafter, referred to as “multilayer type photoreceptor”): the former is a photoreceptor that contains a charge generation material and a charge transport material within the same layer; and the latter is a photoreceptor in which separate layers (charge generation layer and charge transport layer) each including the charge generation material and the charge transport material respectively are laminated.

Among these photoreceptors, in terms of photoreceptor designing, the multilayer photoreceptor is a photoreceptor in which the function of each layer can be easily optimized and the characteristics thereof are also easily controlled, and thus, most of the current photoreceptors are of this type. Almost every multilayer type photoreceptor includes a charge generation layer and a charge transport layer disposed on a substrate in this order.

Regarding the charge transport layer, there are extremely few materials suitable for an electron transport material, whereas many materials having excellent characteristics for a hole transport material are known. For the charge transport layer, polycarbonate resin and polyarylate resin have been mainly used as a binder resin.

For example, low residual potential and high responsiveness in a multilayer type photoreceptor have been realized using polyarylate resin and a charge transport substance having specific properties for a photosensitive layer by designing the surface of the electrophotographic photoreceptor such that the surface has a specific universal hardness and elastic deformation ratio (PTL 1). Such multilayer type photoreceptor is often used for the negative charging system. In a case where the photoreceptor is charged by negative corona discharge, there are cases where the generated ozone adversely affects the environment and photoreceptor properties.

On the contrary, the single-layer type photoreceptor is a photoreceptor that may use any of the negative charging system and the positive charging system, and in a case where the positive charging system is employed for the single-layer type photoreceptor, ozone generation which is the problem in the use of the multilayer type photoreceptor can be reduced. Therefore, despite some of the inferior characteristics compared to those of the negative charging multilayer type photoreceptor in terms of electrical properties, the single-layer type photoreceptor has been partly put into practical use as a single-layer type electrophotographic photoreceptor for positive charging (PTL 2), and studies regarding miniaturization and sensitivity enhancement thereof are ongoing.

For example, regarding the miniaturization, a technique is known, which is capable of providing a single-layer type electrophotographic photoreceptor which does not cause a memory image generation even in an image forming apparatus in which an erase step is not performed and includes a photosensitive layer that contains, in the binder resin, a phthalocyanine compound as a charge generating agent, a hole transport agent, and an electron transport agent, the content of the phthalocyanine compound being 0.1 to 4 wt % with respect to the binder resin mass, the thickness of the photosensitive layer being 10 to 35 μm, and the absolute difference between positive and negative polarity sensitivities measured under certain conditions being 500 V or less (PTL 3).

In addition, regarding the sensitivity enhancement, a technique is known, which is capable of providing a photosensitive layer of which the half decay exposure at the time of positive charging is 0.18 μJ/cm² or less, and the half decay exposure at the time of negative charging is 2 times to 12 times the half decay exposure at the time of positive charging (PTL 4).

### CITATION LIST

### Patent Literature

[PTL 1] JP-A-2011-170041

[PTL 2] JP-A-2-228670

[PTL 3] JP-A-2005-331965

[PTL 4] JP-A-2013-231866

### SUMMARY OF INVENTION

### Technical Problem

However, the technique described in PTL 3 has a problem in that an initial memory appears although the memory after repetitive use is satisfactory. Particularly, the problem is notable for an image forming apparatus not performing an erase step. That is, an object of the present invention is to provide a single-layer type electrophotographic photoreceptor for positive charging having satisfactory initial memory while retaining satisfactory electrical properties and an image forming apparatus including the photoreceptor and exhibiting satisfactory image density.

### Solution to Problem

As a result of intensive studies, the present inventors have found that by allowing a photoreceptor to have a photosensitive layer containing a charge transport substance, a binder resin, and a compound having a specific structure, a photoreceptor that is stable with less decrease in initial charging properties and has favorable initial memory under ozone exposure while retaining the electrical properties during an electrophotographic process in which a charge erase step is not performed, can be provided and has completed the present invention as described below.

The gist of the present invention resides in the following <1> to <9>.

<1> A single-layer type electrophotographic photoreceptor for positive charging, the photoreceptor comprising: a conductive support; and a photosensitive layer disposed on the conductive support, the photosensitive layer including a binder resin, a charge generation material, a hole transport material, and an electron transport material within the same layer,

wherein the electron transport material is a compound represented by Formula (1), and the photosensitive layer contains an aromatic compound represented by Formula (7) and having a molecular weight of 180 to 400:

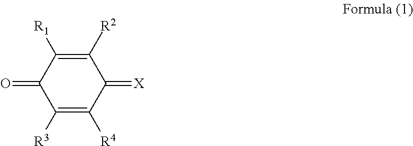

[in Formula (1), R¹ to R⁴ each independently represent a hydrogen atom, an alkyl group having 1 to 20 carbon atoms that may have a substituent, or an alkenyl group having 1 to 20 carbon atoms that may have a substituent, R¹ and R², or R³ and R⁴ may be bonded to each other to form a cyclic structure, and X represents an organic residue having a molecular weight of 120 to 250]

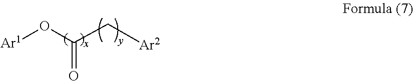

[in Formula (7), Ar¹ and Ar² each independently represent an aryl group that may have a substituent, and x and y each independently represent an integer of 0 to 2].

<2> The single-layer type electrophotographic photoreceptor for positive charging according to the <1>, wherein the content of the aromatic compound represented by Formula (7) in the photosensitive layer is 1 part by mass to 50 parts by mass with respect to 100 parts by mass of the binder resin.
<3> The single-layer type electrophotographic photoreceptor for positive charging according to the <1> or <2>, wherein the charge generation material is a phthalocyanine pigment.
<4> The single-layer type electrophotographic photoreceptor for positive charging according to any one of the <1> or <3>, wherein the binder resin is a polycarbonate resin.
<5> The single-layer type electrophotographic photoreceptor for positive charging according to any one of the <1> to <4>, wherein in Formula (1), X is an organic residue represented by any one of Formulae (3) to (6):

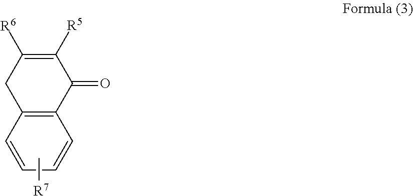

[in Formula (3), R⁵ to R⁷ each independently represent a hydrogen atom or an alkyl group having 1 to 6 carbon atoms]

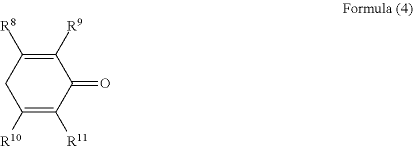

[in Formula (4), R⁸ to R¹¹ each independently represent a hydrogen atom, halogen atom, or an alkyl group having 1 to 6 carbon atoms]

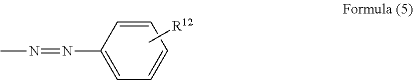

[in Formula (5), R¹² represents a hydrogen atom, an alkyl group having 1 to 6 carbon atoms, or a halogen atom]

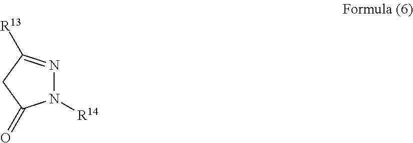

[in Formula (6), R¹³ and R¹⁴ each independently represent a hydrogen atom, an alkyl group having 1 to 6 carbon atoms, or an aryl group having 6 to 12 carbon atoms].

<6> An electrophotographic photoreceptor cartridge, comprising: the single-layer type electrophotographic photoreceptor for positive charging according to any one of the <1> to <5>; and at least one selected from the group consisting of a charging device for charging the electrophotographic photoreceptor, an exposure device for exposing the charged electrophotographic photoreceptor so as to form an electrostatic latent image thereon, and a developing device for developing the electrostatic latent image formed on the electrophotographic photoreceptor.
<7> An image forming apparatus comprising: the single-layer type electrophotographic photoreceptor for positive charging according to any one of the <1> to <5>; a charging device for charging the electrophotographic photoreceptor; an exposure device for exposing the charged electrophotographic photoreceptor to light so as to form an electrostatic latent image thereon; and a developing device for developing the electrostatic latent image formed on the electrophotographic photoreceptor.
<8> The image forming apparatus according to the <7>, which does not provide light for charge erase.
<9> The single-layer type electrophotographic photoreceptor for positive charging according to any one of the <1> to <5>, which is used in an electrophotographic process which does not provide light for charge erase.

### Advantageous Effects of Invention

The present invention makes it possible to provide an electrophotographic photoreceptor that, even when exposed to ozone, is stable without a decrease of initial charging properties and has excellent initial memory, while retaining the electrical properties during an electrophotographic process in which a charge erase step is not performed, an electrophotographic photoreceptor cartridge, and a full-color image forming apparatus.

### BRIEF DESCRIPTION OF DRAWINGS

FIG. 1 is a schematic view showing the configuration of main components of one embodiment of an image forming apparatus of the invention.

FIG. 2 is an X-ray diffraction spectrum of an oxytitanium phthalocyanine used in Examples obtained with CuKα characteristic X-ray.

### DESCRIPTION OF EMBODIMENTS

Hereinafter, detailed description of embodiments for carrying out the invention will be provided. However, the following explanations on constituent elements are merely for representative embodiments of the invention, and the embodiments can be suitably modified within the spirit of the invention. In the present specification, the abbreviation “Et” refers to an ethyl group, “Me” refers to a methyl group, and “t-Bu” refers to a t-butyl group.

<Single-Layer Type Electrophotographic Photoreceptor for Positive Charging>

A single-layer type electrophotographic photoreceptor for positive charging according to the present invention (hereinafter, also referred to as “electrophotographic photoreceptor”) includes a conductive support and a single-layer type photosensitive layer that is formed on the conductive support and contains a binder resin, a charge generation material, a hole transport material, and an electron transport material within the same layer. The electron transport material is a compound represented by Formula (1), and an aromatic compound represented by Formula (2) and having a molecular weight of 180 to 400 is contained in the photosensitive layer.

The content of the aromatic compound represented by Formula (2) and having a molecular weight of 180 to 400 with respect to 100 parts by mass of the binder resin is preferably 1 part by mass or more, more preferably 3 parts by mass or more, even more preferably 5 parts by mass or more, and still more preferably 10 parts by mass or more from the standpoint of characteristics stabilization of the photoreceptor upon repeated use, and preferably 50 parts by mass or less, more preferably 40 parts by mass or less, even more preferably 30 parts by mass or less, and still more preferably 25 parts by mass or less from the standpoint of characteristics stabilization of the photoreceptor upon repeated use.

The thickness of the single-layer type photosensitive layer is preferably 45 μm or less from the standpoint of film formation properties of the photosensitive layer, and more preferably 40 μm or less from the standpoint of high resolution. The thickness of the single-layer type photosensitive layer is preferably 15 μm or more, from the standpoint of long life of the photoreceptor, and more preferably 20 μm or more, from the standpoint of image stability.

[Electron Transport Material]

The photosensitive layer includes a compound represented by Formula (1) as an electron transport material.

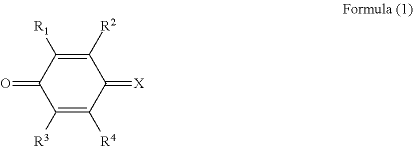

[In Formula (1), R¹ to R⁴ each independently represent a hydrogen atom, an alkyl group having 1 to 20 carbon atoms that may have a substituent, or an alkenyl group having 1 to 20 carbon atoms that may have a substituent. R¹ and R², or R³ and R⁴ may be bonded to each other to form a cyclic structure. X represents an organic residue having a molecular weight of 120 to 250.]

R¹ to R⁴ each independently represent a hydrogen atom, or an alkyl group having 1 to 20 carbon atoms, or an alkenyl group having 1 to 20 carbon atoms that may have a substituent. Examples of the alkyl group having 1 to 20 carbon atoms that may have a substituent include linear alkyl groups such as a methyl group, an ethyl group, and a hexyl group, branched alkyl groups such as an iso-propyl group, a tert-butyl group, and a tert-amyl group, and cyclic alkyl groups such as a cyclohexyl group and a cyclopentyl group.

Preferred of those is an alkyl group having 1 to 15 carbon atoms from the standpoint of versatility of the starting materials, more preferred is an alkyl group having 1 to 10 carbon atoms from the standpoint of handleability during production, and even more preferred is an alkyl group having 1 to 5 carbon atoms. From the standpoint of electron-transporting ability, the alkyl group is preferably a linear alkyl group or a branched alkyl group, among which a methyl group, a tert-butyl group, and a tert-amyl group are more preferable, and from the standpoint of solubility in organic solvents used in coating fluids, a tert-butyl group and a tert-amyl group are even more preferable.

Examples of the alkenyl group having 1 to 20 carbon atoms that may have a substituent include linear alkenyl groups such as an ethenyl group, branched alkenyl groups such as a 2-methyl-1-propenyl group, and cyclic alkenyl groups such as a cyclohexenyl group. Preferred of these is a linear alkenyl group having 1 to 10 carbon atoms from the standpoint of the photo-attenuation characteristics of the photoreceptor.

Regarding the substituents R¹ to R⁴, R¹ and R² together, or R³ and R⁴ together may be bonded to form a cyclic structure. From the standpoint of electron mobility, in the cases where both R¹ and R² are alkenyl groups, R¹ and R² may preferably be bonded together to form an aromatic ring, and it is more preferable that both R¹ and R² are ethenyl groups and bonded together to form a benzene ring structure.

In Formula (1), X represents an organic residue having a molecular weight of 120 to 250, and X is preferably an organic residue represented by any one of the following Formulae (3) to (6) from the standpoint of the photo-attenuation characteristics of the photoreceptor.

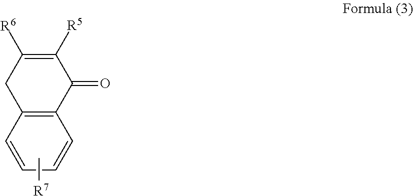

[In Formula (3), R⁵ to R⁷ each independently represent a hydrogen atom or an alkyl group having 1 to 6 carbon atoms.]

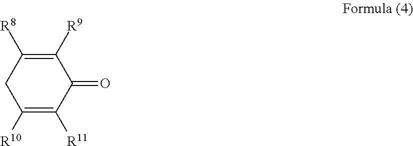

[In Formula (4), R⁸ to R¹¹ each independently represent a hydrogen atom, halogen atom, or an alkyl group having 1 to 6 carbon atoms.]

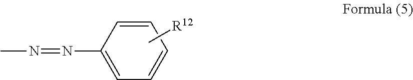

[In Formula (5), R′² represents a hydrogen atom, an alkyl group having 1 to 6 carbon atoms, or a halogen atom.]

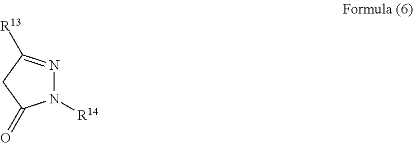

[In Formula (6), R¹³ and R¹⁴ each independently represent a hydrogen atom, an alkyl group having 1 to 6 carbon atoms, or an aryl group having 6 to 12 carbon atoms.]

Examples of the alkyl group having 1 to 6 carbon atoms in R⁵ to R¹⁴ include linear alkyl groups such as a methyl group, an ethyl group, and a hexyl group, branched alkyl groups such as an iso-propyl group, a tert-butyl group, and a tert-amyl group, and cyclic alkyl groups such as a cyclohexyl group. From the standpoint of electron-transporting ability, a methyl group, a tert-butyl group, and a tert-amyl group are more preferable.

Examples of the halogen atom include fluorine, chlorine, bromine, and iodine, and from the standpoint of electron-transporting ability, chlorine is preferable. Examples of the aryl group having 6 to 12 carbon atoms include a phenyl group and a naphthyl group, and from the standpoint of film property of the photosensitive layer, a phenyl group and a naphthyl group are preferable, and a phenyl group is more preferable.

Among the organic residues represented by any one of Formulae (3) to (6), X is preferably an organic residue represented by Formula (3) or (4) from the standpoint of image stability upon repeated image formation, and X is more preferably an organic residue represented by Formula (3).

A compound represented by Formula (1) may be used alone, or may be used in combination with another compound represented by Formula (1) having a different structure, or even may be used in combination with another electron transport material.

Preferable structures of the electron transport materials according to the present invention are exemplified below. The following structures are exemplified in order to make the present invention more concrete and the invention is not limited to the following structures insofar as they do not depart from the concept of the present invention.

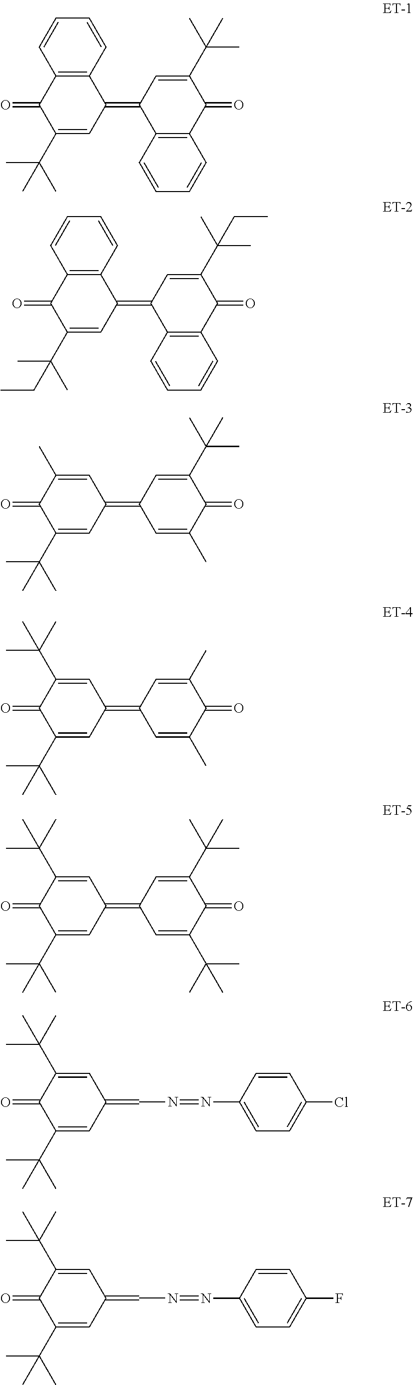

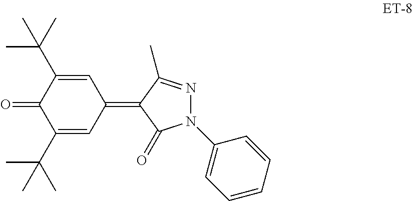 [SMILES: CC1=NN(c2ccccc2)C(=O)C1=C1C=C(C(C)(C)C)C(=O)C(C(C)(C)C)=C1]

Regarding the proportion between the binder resin and the electron transport material in the photosensitive layer, the electron transport material is usually used in an amount of 5 parts by mass or more with respect to 100 parts by mass of the binder resin. The amount thereof is preferably 10 parts by mass or more from the standpoint of reducing of residual potential, and the amount thereof is preferably 20 parts by mass or more from the standpoints of stability upon repeated use and charge mobility. From the standpoint of thermal stability of the photosensitive layer, the charge transport material is usually used in an amount of 100 parts by mass or less. From the standpoint of compatibility between the electron transport material and the binder resin, the amount thereof is preferably 80 parts by mass or less, more preferably 60 parts by weight or less, and even more preferably 50 parts by weight or less.

[Aromatic Compound]

The photosensitive layer includes an aromatic compound represented by Formula (2) having a molecular weight of 180 to 400.

A-O—B Formula (2)

[In Formula (2), A and B each independently represent any of an aryl group having 6 to 20 carbon atoms that may have a substituent, an aralkyl group having 7 to 20 carbon atoms that may have a substituent, an acyl group having 2 to 20 carbon atoms that may have a substituent, or an alkyl group having 6 to 20 carbon atoms that may have a substituent. Either A or B includes a group exhibiting aromaticity.]

Regarding A and B, examples of the aryl group having 6 to 20 carbon atoms that may have a substituent include a phenyl group, a naphthyl group, a biphenyl group, an anthryl group and a phenanthryl group. Among them, from the standpoint of film properties of the photosensitive layer, a phenyl group, a naphthyl group, and a biphenyl group are preferred, and from the standpoint of solubility in organic solvents used for a coating solvent, a phenyl group and a naphthyl group are more preferred, and a naphthyl group is particularly preferred.

Examples of the aralkyl group having 7 to 20 carbon atoms that may have a substituent include a benzyl group, a phenethyl group, and a naphthyl methyl group. Among them, from the standpoint of versatility of the starting materials, a benzyl group and a naphthyl methyl group are preferred, and a benzyl group is more preferred.

Examples of the acyl group having 2 to 20 carbon atoms that may have a substituent include alkyloxy groups such as an acetyl group, and a cyclohexylcarbonyl group, and arylcarbonyl groups such as a benzoyl group, a naphthylcarbonyl group, and a biphenylcarbonyl group. Among these, from the standpoint of versatility of the starting materials, preferred of these is an arylcarbonyl group, more preferred is a benzoyl group or a naphthylcarbonyl group, and even more preferred is a benzoyl group.

Examples of the alkyl groups having 6 to 20 carbon atoms that may have a substituent include cyclic alkyl groups such as a cyclohexyl group, linear alkyl groups such as an octyl group, and branched alkyl groups such as a 2,4-dimethylhexyl group. Among them, from the standpoint of film properties of the photosensitive layer, alkyl groups having a cyclic structure are preferred, and more preferred of those alkyl groups is a cyclohexyl group.

Examples of the substituents that A and B may have include an alkyl group, an aryl group, an alkoxy group, an acyl group, acyloxy group, and a halogen atom.

Specific examples of the alkyl groups include linear alkyl groups such as a methyl group, an ethyl group, an n-propyl group and an n-butyl group, and branched alkyl groups such as an isopropyl group and an ethylhexyl group; and cyclic alkyl groups such as a cyclohexyl group. Examples of the aryl groups include a phenyl group, naphthyl group, biphenyl group, anthryl group, and a phenanthryl group. Examples of the alkoxy group include linear alkoxy groups such as a methoxy group, an ethoxy group, an n-propoxy group and an n-butoxy group, branched alkoxy groups such as an isopropoxy group and an ethylhexyloxy group, cyclic alkoxy groups such as a cyclohexyloxy group, and alkoxy groups having fluorine atoms such as a trifluoromethoxy group, a pentafluoroethoxy group, and a 1,1,1-trifluoroethoxy group. Examples of the acyl group include an acetyl group, a benzoyl group, and a naphthylcarbonyl group. Examples of the acyloxy group include a benzoyloxy group and a naphthylcarboxyoxy group. Examples of the halogen atom include a fluorine atom, chlorine atom, and a bromine atom.

Among them, from the standpoint of versatility of the starting materials for production, preferred are an alkyl group having 1 to 6 carbon atoms, an alkoxy group having 1 to 6 carbon atoms, an acyl group having 1 to 8 carbon atoms, and an acyloxy group having 1 to 8 carbon atoms, and from the standpoint of handleability during production, more preferred of those are an alkyl group having 1 to 6 carbon atoms and an acyloxy group having 1 to 8 carbon atoms.

The molecular weight of the aromatic compound is, from the standpoint of film-forming properties of the photosensitive layer, preferably 370 or less, more preferably 350 or less, and even more preferably 325 or less, and particularly preferably 300 or less, and from the standpoint of compatibility between the photosensitive layer and the aromatic compound, is preferably 190 or more, and more preferably 200 or more.

Among the aromatic compounds represented by Formula (2), a compound represented by Formula (7) is preferable from the standpoint of initial memory.

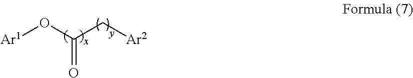

[In formula (7), Ar¹ and Ar² each independently represent a phenyl group or a naphthyl group that may have any of an alkyl group, an alkoxy group, and a phenyl group. x and y represent 0 or 1.]

The alkyl group, the alkoxy group, and the phenyl group that may be included in Ar¹ and Ar² are the same as those described as the substituents that may be included in A and B.

An aromatic compound represented by Formula (2) may be used alone, or may be used in combination with another aromatic compound represented by Formula (2) having a different structure. Structures of the aromatic compounds are exemplified below. The following structures are exemplified in order to make the present invention more concrete and the invention is not limited to the following structures insofar as they do not depart from the concept of the present invention.

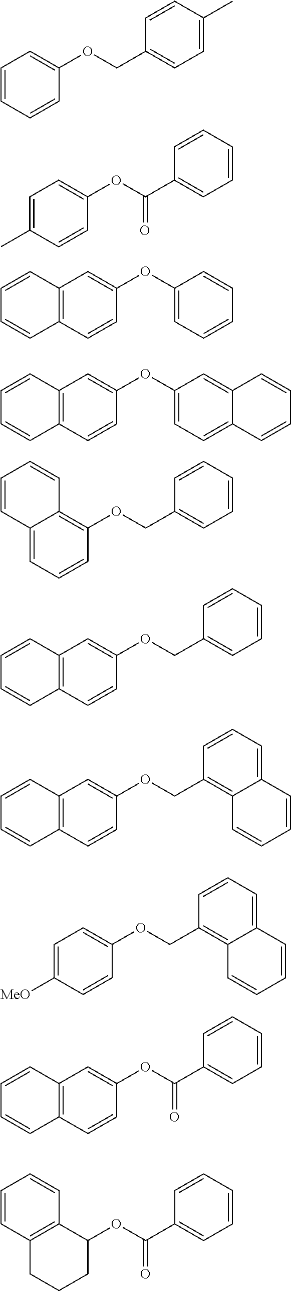

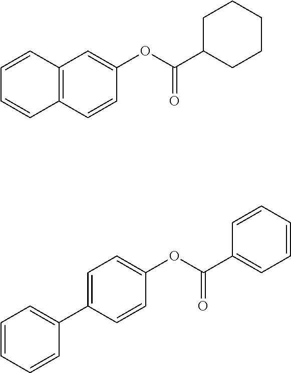 [SMILES: O=C(Oc1ccc2ccccc2c1)C1CCCCC1 ; O=C(Oc1ccc(-c2ccccc2)cc1)c1ccccc1]

Regarding the proportion between the binder resin and the aromatic compound in the photosensitive layer, the aromatic compound is usually used in an amount of 1 part by mass or more with respect to 100 parts by mass of the binder resin. The amount of the aromatic compound is preferably 3 parts by mass or more from the standpoint of initial memory, and more preferably 5 parts by mass or more, and even more preferably 10 parts by mass or more from the standpoint of stability of electric potential upon repeated use. From the standpoint of compatibility between the binder resin and the aromatic compound, the aromatic compound is usually used in an amount of 50 parts by mass or less. From the standpoint of film-forming properties of the photosensitive layer, the amount thereof is preferably 40 parts by mass or less, and more preferably 30 parts by mass or less.

Regarding the proportion between the electron transport material and the aromatic compound in the photosensitive layer, the aromatic compound is usually used in an amount of 1 part by mass or more with respect to 100 parts by mass of the electron transport material. From the standpoint of initial memory, the amount thereof is preferably 10 parts by mass or more. From the standpoint of repeating memory, the amount thereof is preferably 30 parts by mass or more. From the standpoint of stability of the coating fluids, the aromatic compound is usually used in an amount of 150 parts by mass or less. From the standpoint of electrical properties, the amount thereof is preferably 100 parts by mass or less, and more preferably 80 parts by mass or less.

[Binder Resin]

Examples of the binder resin include thermoplastic resins and various thermosetting resins, such as vinyl polymers, e.g., polymethyl methacrylate, polystyrene, and polyvinyl chloride, copolymers thereof, and polycarbonate, polyarylate, polyester, polyester polycarbonate, polysulfone, phenoxy, epoxy, and silicone resins. Preferred of these resins are polycarbonate resins and polyarylate resins from the standpoint of photo-attenuation characteristics and mechanical strength of the photoreceptor.

Specific examples of repeating structural units suitable for the binder resins are shown below. The following examples are mere examples, and known binder resins may be used so long as the use thereof does not depart from the spirit of the invention.

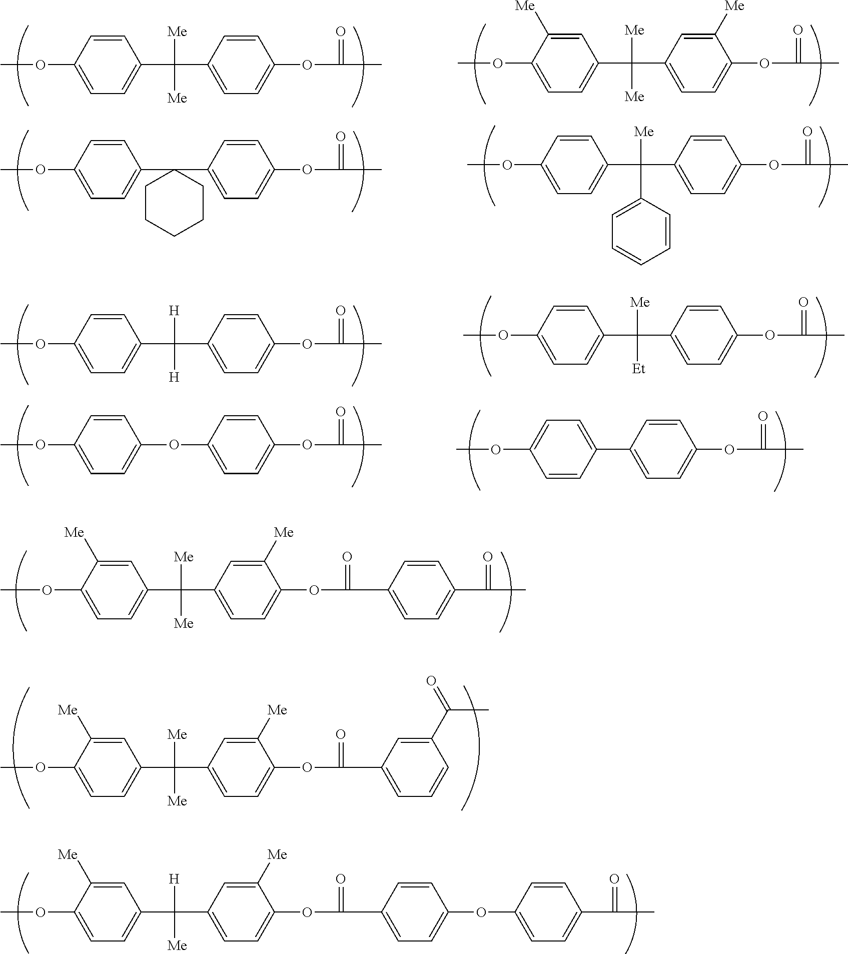

The viscosity-average molecular weight of the binder resin is, from the standpoint of mechanical strength, usually 20,000 or more, preferably 30,000 or more, more preferably 40,000 or more, and even more preferably 50,000 or more, and from the standpoint of production of coating fluid used for photosensitive layer formation, the viscosity-average molecular weight thereof is usually 150,000 or less, preferably 120,000 or less, and more preferably 100,000 or less.

[Charge Generation Material]

Examples of the charge generation material include inorganic photoconductive materials, such as selenium, alloys thereof, and cadmium sulfide, and organic photoconductive materials such as organic pigments. Preferred of these are organic photoconductive materials, and particularly preferred are organic pigments.

Examples of the organic pigments include phthalocyanine pigments, azo pigments, dithioketopyrrolopyrrole pigments, squalene (squarylium) pigments, quinacridone pigments, indigo pigments, perylene pigments, polycyclic quinone pigments, anthanthrone pigments, and benzimidazole pigments.

Preferred of those organic pigments are phthalocyanine pigments and azo pigments. In the case of using any of these organic pigments as the charge generation material, the organic pigment is used usually in the form of a dispersion layer in which fine particles thereof have been bound with any of various binder resins.

In the case of using the phthalocyanine pigment as the charge generation material, use may be made specifically of metal-free phthalocyanines and phthalocyanine compounds to which a metal, e.g., copper, indium, gallium, tin, titanium, zinc, vanadium, silicon, germanium, or aluminum, or an oxide, halide, hydroxide, alkoxide, or another form of the metal has coordinated, these phthalocyanines and phthalocyanine compounds having respective crystal forms, and phthalocyanine dimers in which oxygen or other atoms are used as crosslinking atoms.

Particularly preferred are X-form and τ-form metal-free phthalocyanines, which are crystal forms having high sensitivity, A-form (also called β-form), B-form (also called α-form), D-form (also called Y-form), and other titanyl phthalocyanines (other name: oxytitanium phthalocyanines), vanadyl phthalocyanines, chloroindium phthalocyanines, hydroxyindium phthalocyanines, II-form and other chlorogallium phthalocyanines, V-form and other hydroxygallium phthalocyanines, G-form, I-form, and other μ-oxo-gallium phthalocyanine dimers, and II-form and other μ-oxo-aluminum phthalocyanine dimers.

Particularly preferred of these phthalocyanines are A-form (also called β-form) and B-form (also called α-form) titanyl phthalocyanines, D-form (Y-form) titanyl phthalocyanine characterized by showing a distinct peak at a diffraction angle 2θ(±0.2°) of 27.1° or 27.3° in X-ray powder diffractometry, II-form chlorogallium phthalocyanine, V-form hydroxygallium phthalocyanine, the hydroxygallium phthalocyanine characterized by having a most intense peak at 28.1° or characterized by having no peak at 26.2°, having a distinct peak at 28.1°, and having a half-value width W at 25.9° of 0.1°≦W≦0.4°, a G-form μ-oxo-gallium phthalocyanine dimer, and X-form metal-free phthalocyanines.

A single phthalocyanine compound may be used alone, or a mixture of several phthalocyanine compounds or a phthalocyanine compound in a mixed-crystal state may be used. The state in which phthalocyanine compounds are mixed or the mixed-crystal state may be one obtained by mixing the constituent elements later, or may be one formed in steps for phthalocyanine compound production and treatments, such as synthesis, pigment formation, crystallization, etc. Known as such treatments are an acid pasting treatment, grinding treatment, solvent treatment, and the like. Examples of methods for producing a mixed-crystal state include a method in which two kinds of crystals are mixed together and the resultant mixture is mechanically ground and made amorphous and is then subjected to a solvent treatment to thereby convert the amorphous state into a specific crystalline state, as described in JP-A-10-48859.

The particle diameter of the charge generation material is usually 1 μm or less, and preferably used are particles having a particle diameter of 0.5 μm or less. The amount of the charge generation material to be dispersed in the photosensitive layer is usually 0.1 parts by mass or more, preferably 0.5 parts by mass or more, and more preferably 1.0 part by mass or more with respect to 100 parts by mass of the binder resin, and from the standpoint of sensitivity, is usually 20 parts by mass or less, preferably 15 parts by mass or less, and more preferably 10 parts by mass or less.

[Hole Transport Material]

Examples of the hole transport material include electron-donating substances such as heterocyclic compounds, e.g., carbazole derivatives, indole derivatives, imidazole derivatives, oxazole derivatives, pyrazole derivatives, thiadiazole derivatives, and benzofuran derivatives, aniline derivatives, hydrazone derivatives, aromatic amine derivatives, aryl amine derivatives, stilbene derivatives, butadiene derivatives, and enamine derivatives, and compounds each made up of two or more of these compounds bonded together or polymers each including, in the main chain or a side chain thereof, a group constituted of any of these compounds.

Preferred among those electron-donating substances are carbazole derivatives, aromatic amine derivatives, aryl amine derivatives, stilbene derivatives, butadiene derivatives, enamine derivatives, and compounds each made up of two or more of these compounds bonded together or polymers each including, in the main chain or a side chain thereof, a group constituted of any of these compounds. Particularly preferred among them are carbazole derivatives, aromatic amine derivatives, aryl amine derivatives, stilbene derivatives, butadiene derivatives, enamine derivatives, and compounds each made up of two or more of these compounds bonded together.

Examples of the general formulae of preferable hole transport material structures are shown below.

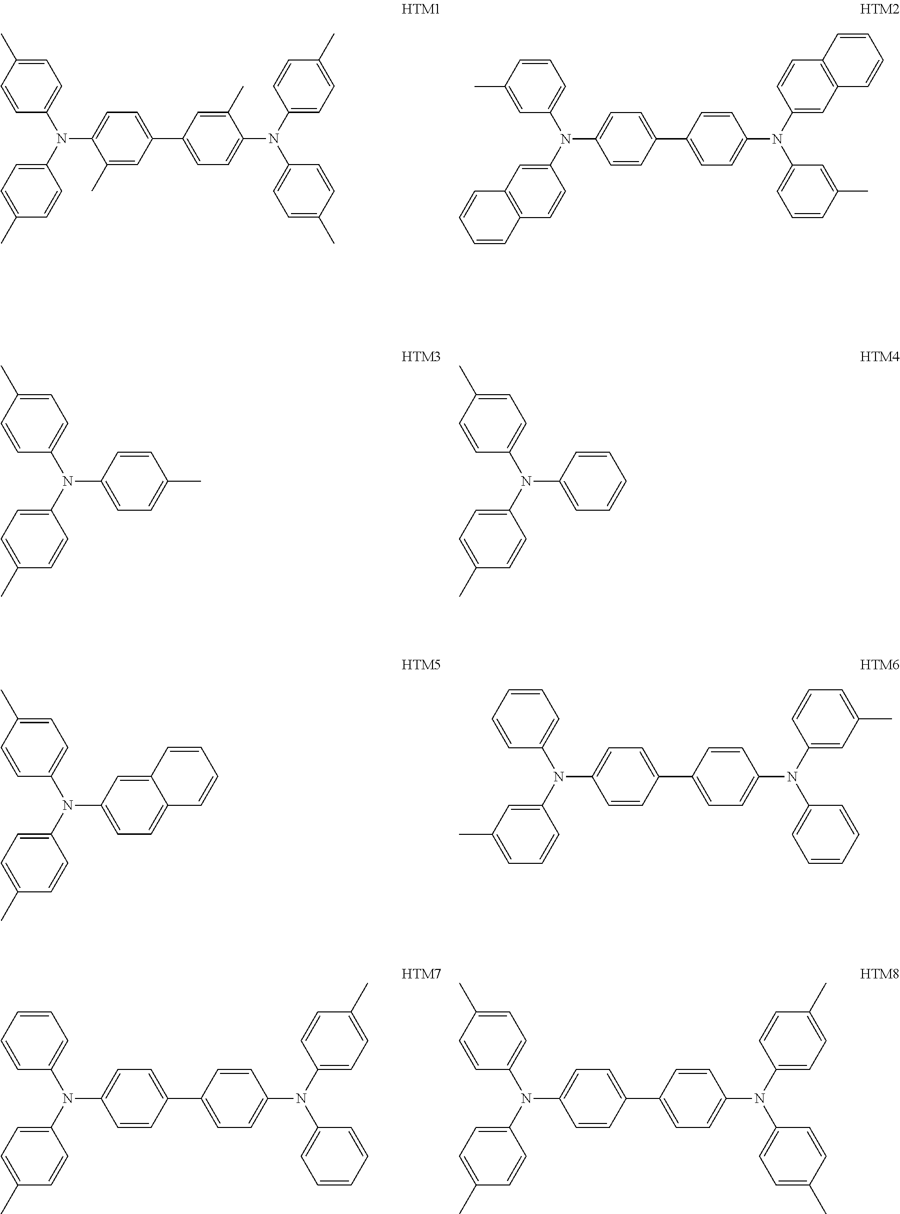

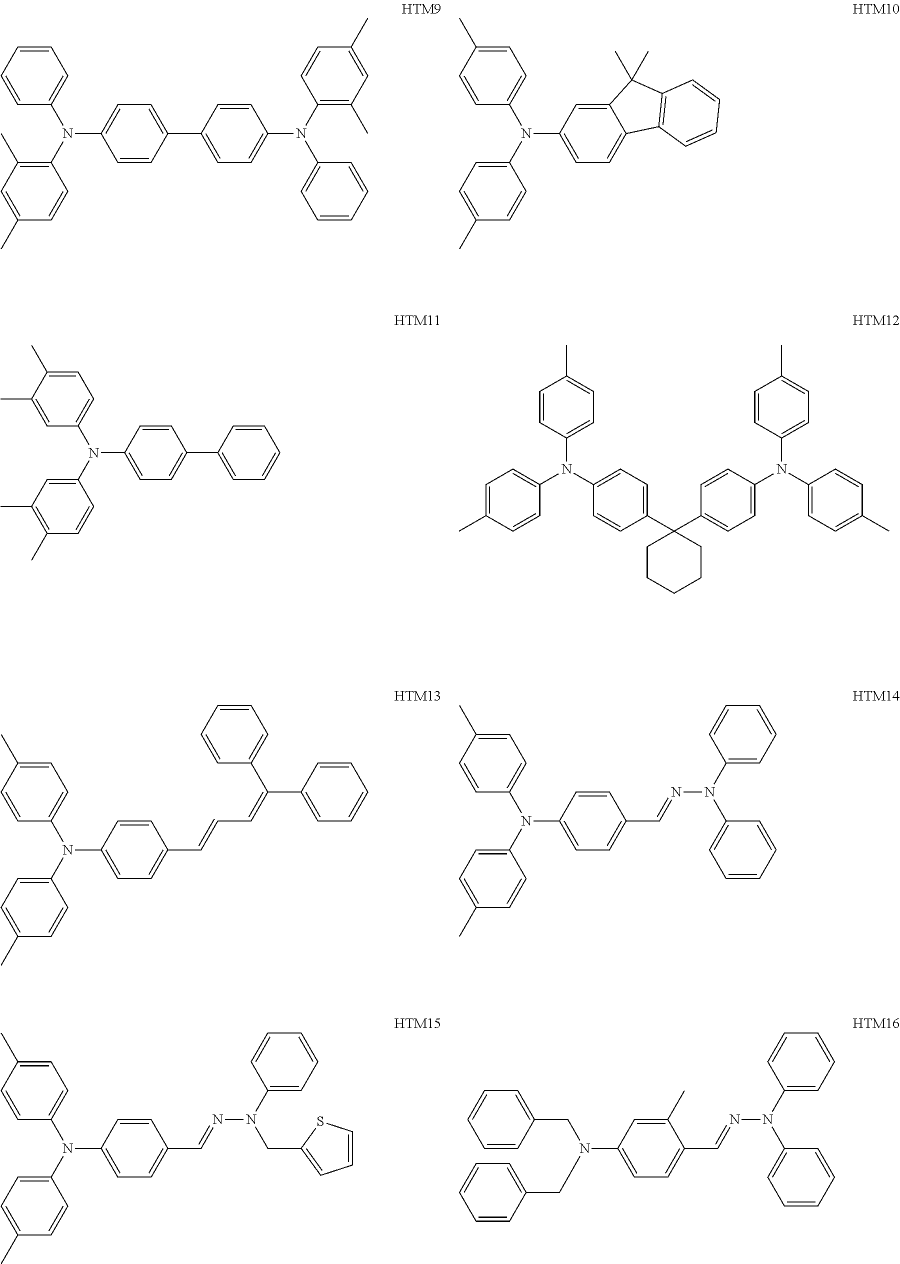

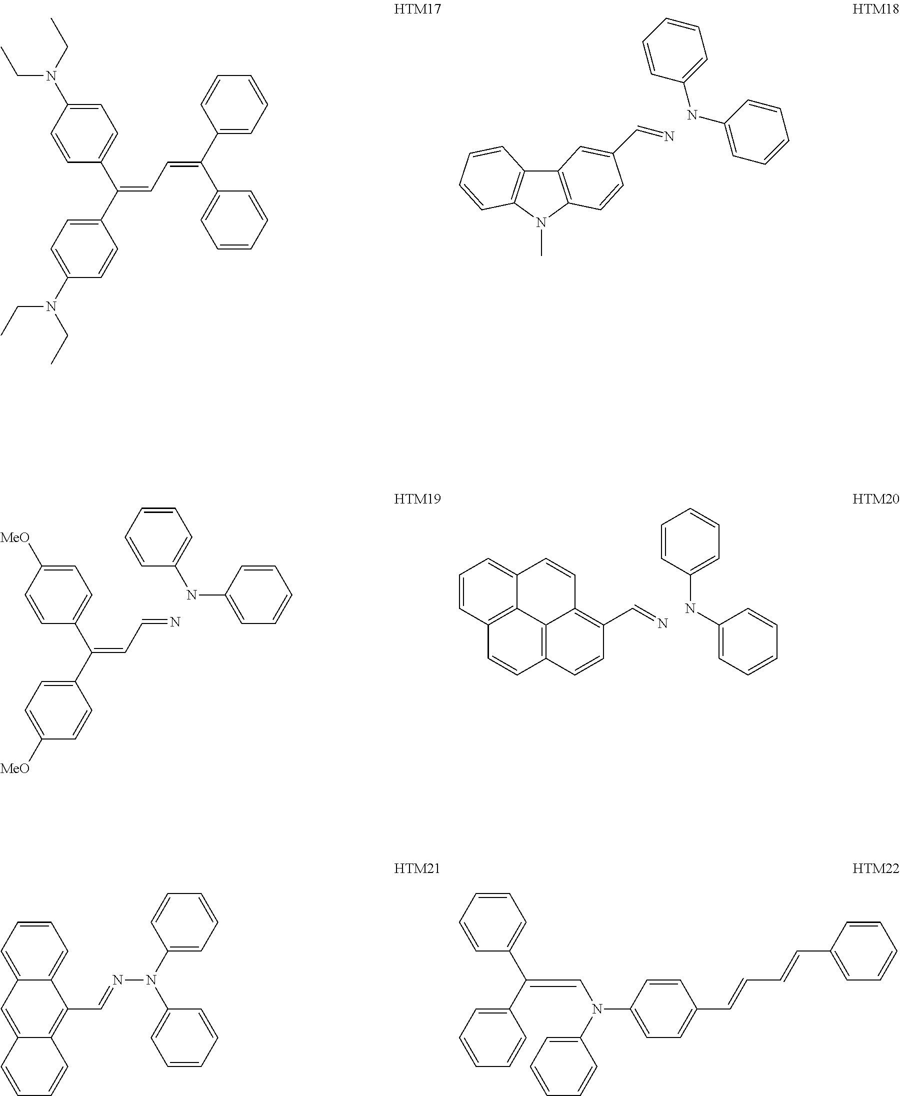

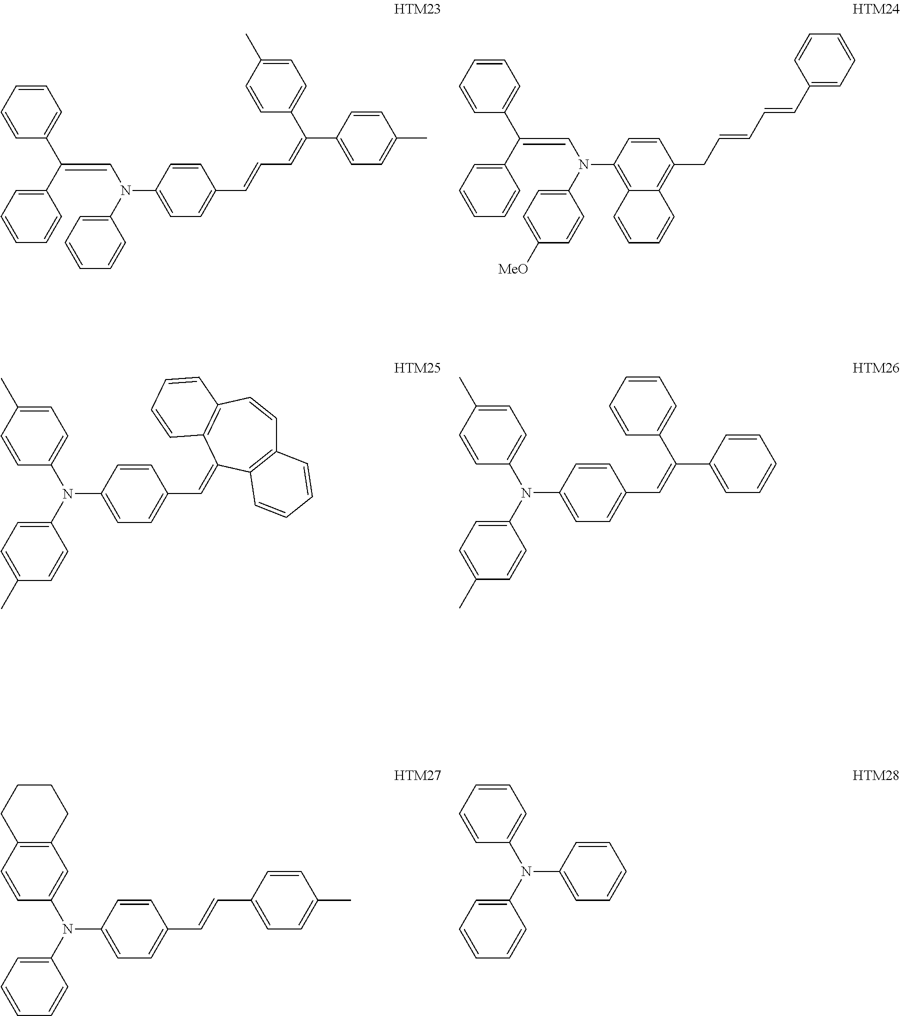

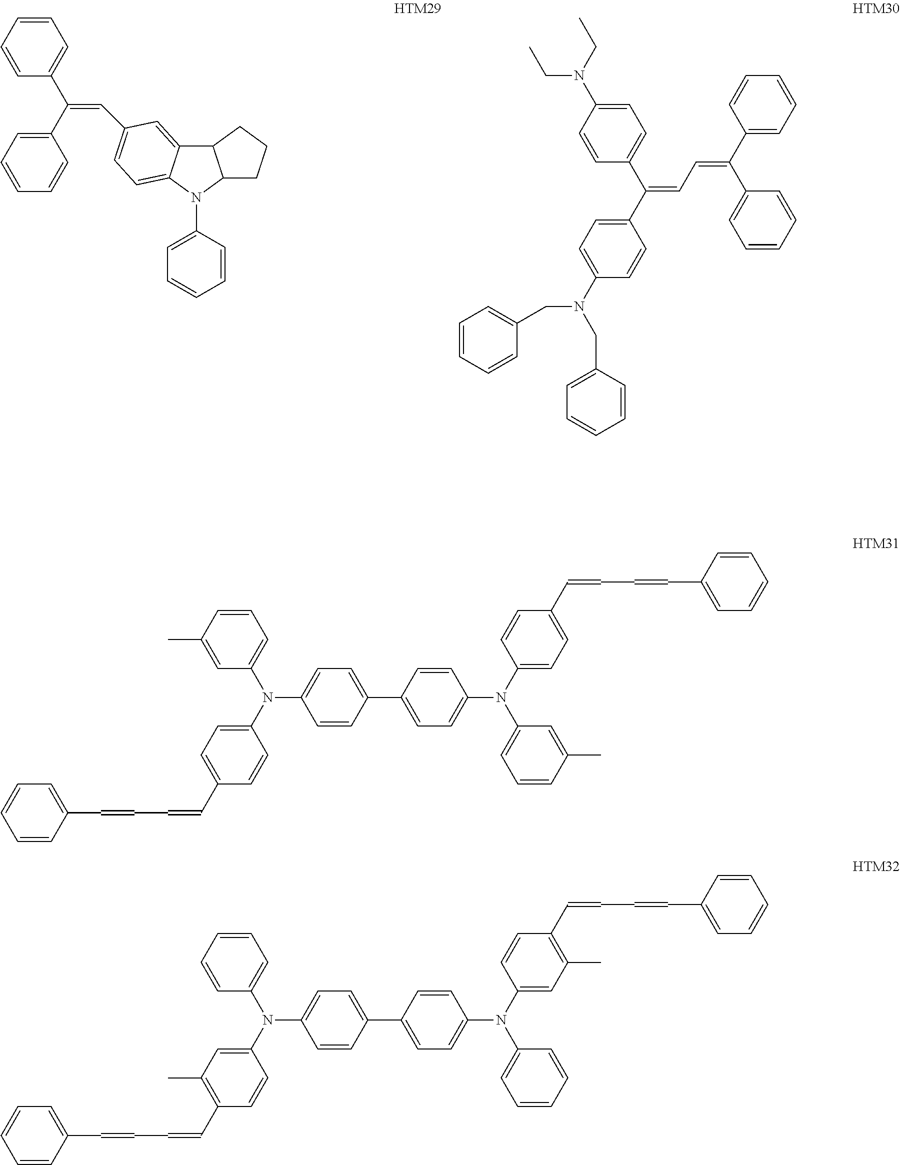

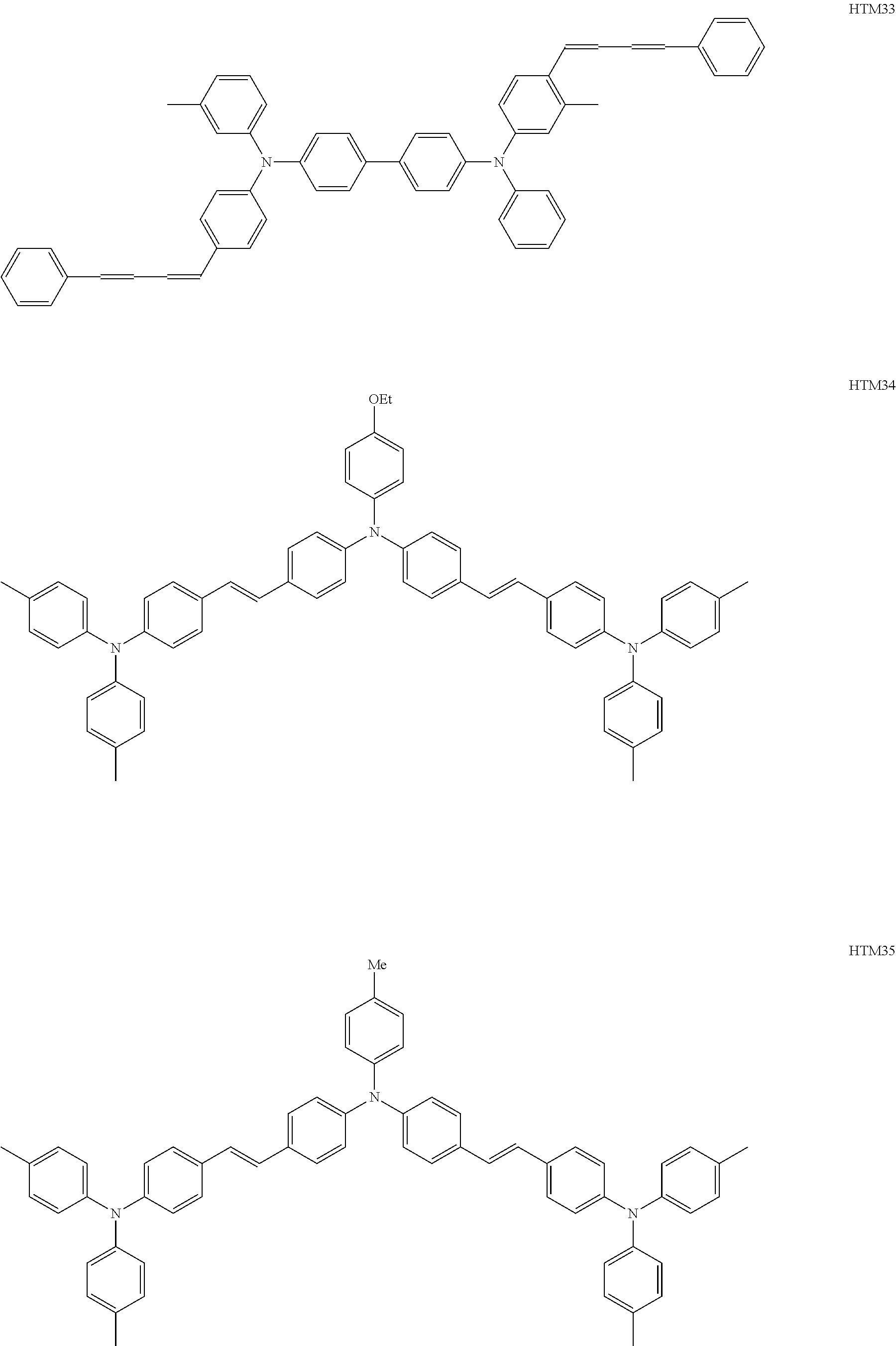

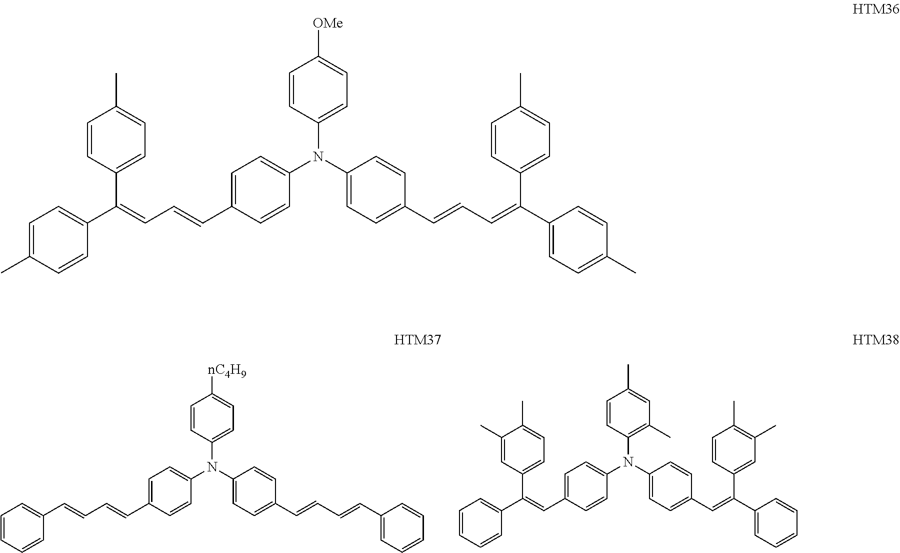

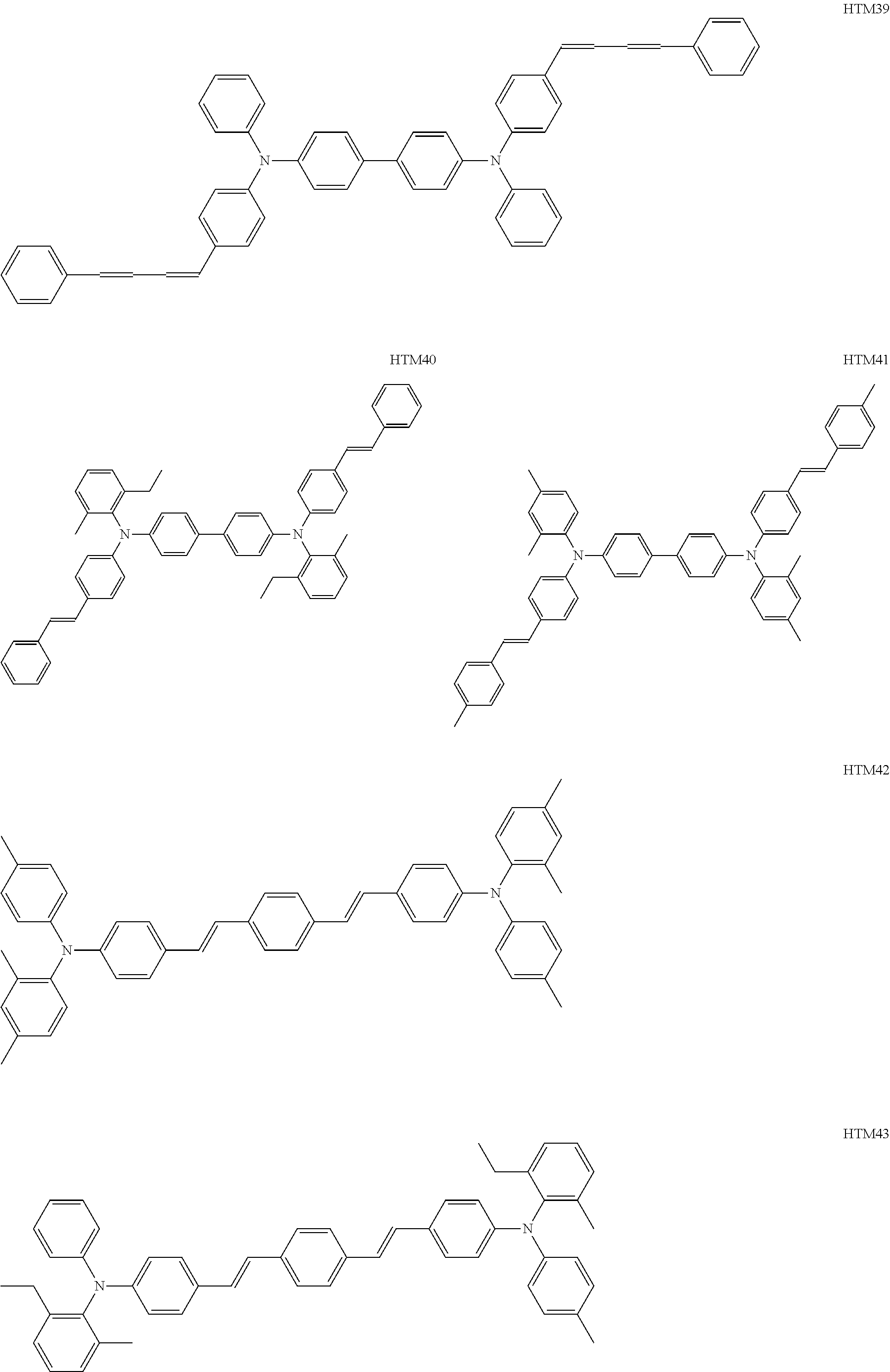

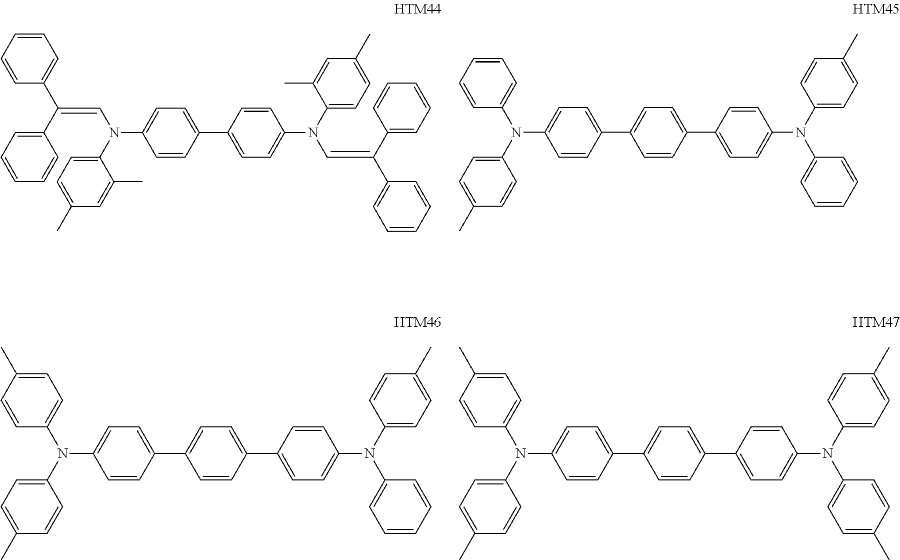

Among the hole transport materials, preferred are compounds having a structure of HTM 34, 35, 36, 37, 39, 40, 41, 42, 43, or 44 from the standpoint of residual potential.

Although the binder resin and the hole transport material that constitute the photosensitive layer may be blended in any desired proportion, the ratio of the hole transport material to be blended is usually 20 parts by mass or more with respect to 100 parts by mass of the binder resin. Within the range, the ratio of the hole transport material to be blended is preferably 30 parts by mass or more with respect to 100 parts by mass of the binder resin from the standpoint of reducing residual potential, and more preferably 40 parts by mass or more from the standpoints of stability upon repeated use and charge mobility.

The ratio of the hole transport material to be blended is preferably 200 parts by mass or less with respect to 100 parts by mass of the binder resin from the standpoint of thermal stability of the photosensitive layer, and more preferably 150 parts by mass or less from the standpoints of compatibility between the hole transport material and the binder resin.

Although the binder resin and the charge transport material (electron transport material and/or hole transport material) that constitute the photosensitive layer may be blended in any desired proportion, the ratio of the charge transport material to be blended is usually 20 parts by mass or more with respect to 100 parts by mass of the binder resin. Within the range, the ratio of the charge transport material to be blended is preferably 30 parts by mass or more with respect to 100 parts by mass of the binder resin from the standpoint of reducing residual potential, and more preferably 40 parts by mass or more from the standpoints of stability upon repeated use and charge mobility.

The ratio of the charge transport material to be blended is preferably 200 parts by mass or less with respect to 100 parts by mass of the binder resin from the standpoint of thermal stability of the photosensitive layer, and more preferably 150 parts by mass or less, even more preferably 125 parts by mass or less, and still more preferably 100 parts by mass or less from the standpoint of compatibility between the charge transport material and the binder resin. In a case where two or more the charge transport materials are used, the total amount of the electron transport material is adjusted to fall within the above range.

[Conductive Support]

Although the conductive support is not particularly limited, mainly used as the conductive support is, for example, a metallic material such as aluminum, an aluminum alloy, stainless steel, copper, or nickel, a resinous material to which electrical conductivity has been imparted by adding a conductive powder, e.g., a metal, carbon, or tin oxide powder, or a resin, glass, paper, or the like, having a surface on which a conductive material, e.g., aluminum, nickel, or ITO (indium oxide/tin oxide) has been vapor deposited or applied. One selected from these may be used alone, or two or more selected from these can be used in any desired combination and in any desired proportion.

Examples of the form of the conductive support include a drum, sheet, belt, or the like. Use may be made of a metallic conductive support having a surface coated with a conductive material having a suitable resistance in order to control the conductivity and surface properties thereof, and to coat defects.

In a case where a metallic material such as an aluminum alloy is used as a conductive support, this material may be used after an anodized coating film is formed thereon. In the case where an anodized coating film has been formed, the material is preferably subjected to a pore-filling treatment by a known method.

The surface of the support may be smooth, or may have been roughened by using a special machining method or by performing a grinding treatment. Alternatively, use may be made of a support having a roughened surface obtained by incorporating particles with an appropriate particle diameter into the material for constituting the support. A drawn pipe can be used as such without subjecting the pipe to machining, for the purpose of cost reduction.

[Undercoat Layer]

An undercoat layer may be disposed between the conductive support and the photosensitive layer in order to improve adhesiveness, blocking properties, etc. As the undercoat layer, use may be made, for example, of a resin alone or a resin in which particles of a metal oxide or the like or an organic pigment or the like is dispersed.

Examples of the metal oxide particles used for the undercoat layer include particles of a metal oxide containing one metallic element, such as titanium oxide, aluminum oxide, silicon oxide, zirconium oxide, zinc oxide, and iron oxide, and particles of a metal oxide containing a plurality of metallic elements, such as calcium titanate, strontium titanate, and barium titanate. One of those particles may be used alone, or two or more of those particles may be mixed together and used. Preferred of these metal oxide particles are titanium oxide and aluminum oxide. Particularly preferred is titanium oxide.

The titanium oxide particles may have a surface which has been treated with an inorganic material such as tin oxide, aluminum oxide, antimony oxide, zirconium oxide, and silicon oxide, or with an organic material such as stearic acid, a polyol and a silicone. The crystal form of the titanium oxide particles to be utilized may be any of rutile, anatase, brookite, and amorphous. The titanium oxide particles to be utilized may include particles in a plurality of crystal states.

Although metal oxide particles having various particle diameters can be utilized, from the standpoint of characteristics thereof and fluid stability, preferably used of those particles are particulate metal oxides having an average primary-particle diameter of 1 nm to 100 nm, and particularly preferably 10 nm to 50 nm.

The undercoat layer is preferably formed so as to be configured of a binder resin and metal oxide particles dispersed therein. Examples of the binder resin to be used in the undercoat layer include phenoxy, epoxy, polyvinyl pyrrolidone, polyvinyl alcohol, casein, polyacrylic acid, celluloses, gelatin, starch, polyurethane, polyimide and polyamide, and one of these resins may be used alone, or may be used together with a hardener to come into a hardened state. Among them, alcohol-soluble copolyamides, modified polyamide, and the like are preferred because of the excellent dispersibility and applicability they exhibit.

A layer corresponding to the charge generation layer that constitutes a multilayer type photoreceptor can be employed as the undercoat layer of the single-layer type photosensitive layer. In this case, preferably utilized is an undercoat layer that has been coated with phthalocyanine pigments, azo pigments, perylene pigments, or the like dispersed in the binder resin. In this case, the undercoat layer exhibits excellent adhesiveness and electrical properties. Preferably used as the binder resin are polyvinyl acetal resins, and polyvinyl butyral resins are particularly preferred from the standpoint of electrical properties.

Although the addition ratio of dispersants such as particles or pigments to the binder resin can be selected at will, the ratio is preferably in a range of 10 mass % to 500 mass % from the standpoints of dispersion stability and applicability. Although thickness of the undercoat layer can be selected at will, the thickness is preferably 0.1 μm to 25 μm from the standpoint of the photoreceptor properties and applicability. A known antioxidant and the like may be incorporated into the undercoat layer. Several layers having different constitutions may also be provided as the undercoat layer.

[Other Additives]

The photosensitive layer or respective layers that constitute the photosensitive layer may contain known additives such as an antioxidant, plasticizer, ultraviolet absorber, electron-attracting compound, leveling agent, and visible-light-shielding agent for the purposes of enhancing the film-forming properties, flexibility, applicability, non-fouling properties, gas resistance, light resistance, and the like. Furthermore, particles formed of a fluororesin, silicone resin, polyethylene resin, or the like, or particles of an inorganic compound may be incorporated into the charge transport layer for the purposes of reducing the frictional resistance or wear of the photoreceptor surface, heightening the efficiency of toner transfer from the photoreceptor to a transfer belt or to paper, and the like.

<Methods for Forming the Layers>

The layers that constitutes the above-described photoreceptor may be formed by repeatedly and successively performing application and drying steps, in which a coating fluid obtained by dissolving or dispersing, in a solvent, substances to be incorporated is applied to a conductive support by a known method, such as dip coating, spray coating, nozzle coating, bar coating, roll coating, or blade coating, and dried to form each layer.

Although solvents or dispersion medium to be used in preparation of the coating fluid is not limited to particular solvents or dispersion media, specific examples thereof include alcohols such as methanol, ethanol, propanol, and 2-methoxyethanol, ethers such as tetrahydrofuran, 1,4-dioxane, and dimethoxyethane, esters such as methyl formate, ethyl acetate, ketones such as acetone, methyl ethyl ketone, cyclohexanone, and 4-methoxy-4-methyl-2-pentanone, aromatic hydrocarbons such as benzene, toluene, and xylene, chlorinated hydrocarbons such as dichloromethane, chloroform, 1,2-dichloroethane, 1,1,2-trichloroethane, 1,1,1-trichloroethane, tetrachloroethane, 1,2-dichloropropane, and trichloroethylene, nitrogen-containing compounds such as n-butylamine, isopropanolamine, diethylamine, triethanolamine, ethylenediamine, and triethylenediamine, and aprotic polar solvents such as acetonitrile, N-methylpyrrolidone, N,N-dimethylformamide, and dimethyl sulfoxide. One kind selected from these may be used alone, or any desired two or more selected from these may be used in combination.

Although the amount of the solvent or dispersion medium to be used is not particularly specified, the amount thereof is preferably adjusted, as appropriate, in accordance with the intended purpose of each layer and nature of the selected solvent and dispersion media so as to set properties such as the solid content concentration or viscosity of the coating fluid, to be in desired ranges.

Regarding the drying of the coating fluid, it is preferable that after room-temperature drying to the touch, the coating fluid is dried with heating in a temperature range of, usually, 30° C. to 200° C. for 1 minute to 2 hours either in a stationary atmosphere or with air blowing. The heating temperature may be constant, or the heating for drying may be performed while changing the heating temperature.

<Image Forming Apparatus>

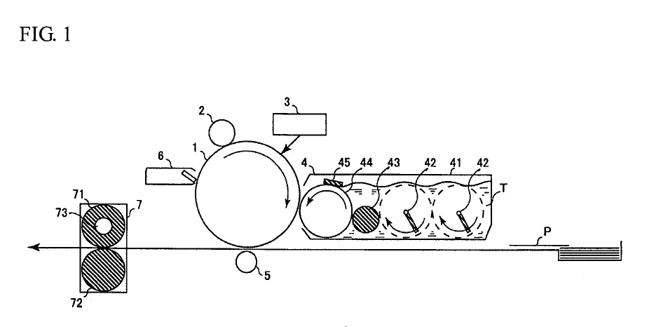

Next, description regarding an embodiment of an image forming apparatus using the electrophotographic photoreceptor of the present invention (image forming apparatus of the present invention) will be provided with reference to FIG. 1, which illustrates the configuration of main components of the apparatus. However, embodiments of the present invention are not limited to the following description, and the embodiments can be freely modified without departing from the spirit and scope of the present invention.

As shown in FIG. 1, the image forming apparatus includes an electrophotographic photoreceptor 1, a charging device 2, an exposure device 3, and a developing device 4, and may further include, as necessary, a transfer device 5, a cleaning device 6, and a fixing device 7.

The electrophotographic photoreceptor 1 is not particularly limited as long as it is an electrophotographic photoreceptor according to the present invention. FIG. 1 depicts, as an example thereof, a drum-shaped photoreceptor in which the above-described photosensitive layer is formed on a surface of a cylindrical conductive support. The charging device 2, the exposure device 3, the developing device 4, the transfer device 5 and the cleaning device 6 are respectively disposed along an outer peripheral surface of the electrophotographic photoreceptor 1.

The charging device 2, which is the one that charges the electrophotographic photoreceptor 1, uniformly charges a surface of the electrophotographic photoreceptor 1 to a predetermined potential. Examples of typical charging devices include non-contact corona charging devices such as a corotron and a scorotron, and contact charging devices (direct charging devices) that charges the photoreceptor by bringing a charging member to which a voltage is being applied into contact with the photoreceptor surface.

Examples of the contact charging devices used in the invention include charging rollers and charging brushes. The charging device depicted in FIG. 1, as an example of the charging device 2, is a roller type-charging device (charging roller). Charging rollers are typically produced by integrally molding a resin and additives such as a plasticizer with a metallic shaft and may have a multilayer structure as necessary. As the voltage to be applied for the charging, a direct-current voltage only can be used or an alternating current superimposed on a direct current is also usable.

The exposure device 3 is not particularly limited as long as it is an exposure device that is capable of exposing the electrophotographic photoreceptor 1 to light and forming an electrostatic latent image on the photosensitive surface of the electrophotographic photoreceptor 1. Specific examples thereof include a halogen lamp, fluorescent lamp, laser (semiconductor laser or He—Ne laser), and LED. Exposure may be performed by an internal photoreceptor exposure technique, or the like. Although the wavelength of the exposing light can be selected at will, use can be made of, for example, monochromatic light of 780 nm, monochromatic light having a slightly short wavelength in a range of 600 nm to 700 nm, monochromatic light having a short wavelength in a range of 380 nm 500 nm.

Although a toner T can be selected at will, use can be made of polymerization toners obtained by methods such as suspension polymerization, emulsion polymerization, and the like in addition to powdery toners. In particular, in a case where polymerization toners are used, preferred are toners having a small particle diameter of around 4 to 8 μm, and use can be made of the toner particles having various shapes from a nearly spherical shape to potato-like shape apart from sphere. Polymerization toners, which are excellent in terms of evenness in charging and transferability, are preferably used for increasing image quality.

The transfer device 5 is not limited to a particular kind, and use can be made of devices using any technique such as an electrostatic transfer technique, pressure transfer technique, adhesive transfer technique, or the like, e.g., corona transfer, roller transfer, or belt transfer. Herein, it is assumed that the transfer device 5 includes a transfer charger, a transfer roller, and a transfer belt configured to face the electrophtographic photoreceptor 1. This transfer device 5 applies a predetermined voltage (transfer voltage) in a polarity opposite to the charge potential of the toner T, and thereby transfers a toner image formed on the electrophotographic photoreceptor 1 onto a recording paper (paper and medium) P.

The cleaning device 6 is not particularly limited, use may be made of any cleaning device such as a brush cleaner, magnetic brush cleaner, electrostatic brush cleaner, magnetic roller cleaner, blade cleaner, or the like. The cleaning device 6 scrapes off residual toners attached to the photoreceptor 1 with a cleaning member to collect the residual toners. However, in a case where the residual toners on the surface of the photoreceptor are either small or almost non-existent, the cleaning device 6 may be omitted.

The fixing device 7 includes an upper fixing member (fixing roller) 71 and a lower fixing member (fixing roller) 72, and either the upper fixing member 71 or the lower fixing member 72 includes a heating member 73 in the inside thereof. FIG. 1 depicts an example in which the heating device 73 is included in the upper fixing member 71. As the respective fixing members 71 and 72 on the upper and lower portions, use may be made of known thermal fixing members such as a fixing roll formed by coating a pipe of metal, e.g., stainless steel and aluminum with a silicon rubber, a fixing roll coated with Teflon (registered trademark) resin, and a fixing sheet. In addition, either the upper fixing member 71 or the lower fixing member 72 may be configured so as to supply a release agent such as silicone oil for improving releasability thereof. They may also be configured so as to forcibly apply pressure to one another by a spring.

The toner that has been transferred onto the recording paper P is thermally heated until the toner is molten, while passing through between the upper fixing member 71 that has been heated to a predetermined temperature and the lower fixing member 72. After passing therethrough, the toner is cooled and thereby fixed onto the recording paper P. Without being limited to a particular kind, the fixing device may include a fixing device using any technique, e.g., hot-roller fixing, flash fixing, oven fixing, and pressure fixing, in addition to the ones used herein.

The electrophotographic apparatus configured as such records an image as follows. That is, first, the charging device 2 charges a surface (photosensitive surface) of the electrophotographic photoreceptor 1 to a predetermined potential (for example, −600 V). At this time, the charging device 2 may charge the photosensitive surface of the electrophotographic photoreceptor using a direct-current voltage or may charge the same using an alternate-current voltage superimposed with a direct-current voltage.

Next, the charged photosensitive surface of the electrophotographic photoreceptor 1 is exposed to light by the exposure device 3 in accordance with an image to be recorded to form an electrostatic latent image on the photosensitive surface. Subsequently, the developing device 4 develops the electrostatic latent image formed on the photosensitive surface of the electrophotographic photoreceptor 1.

The developing device 4 forms the toner T supplied by a supply roller 43 into a thin layer using a regulating member (developing blade) 45 and charges the toner T to a predetermined polarity (here, the same polarity as that of the charge potential of the electrophotographic photoreceptor 1: negative polarity) by means of frictional electrification, transfers the toner while supporting the toner with a developing roller 44, and brings the toner into contact with the surface of the electrophotographic photoreceptor 1.

When the charged toner T supported with the developing roller 44 comes into contact with the surface of the electrophotographic photoreceptor 1, a toner image corresponding to the electrostatic latent image is formed on the photosensitive surface of the electrophotographic photoreceptor 1. The toner image is transferred by the transfer device 5 onto the recording paper P. Thereafter, the toners remaining on the photosensitive surface of the electrophotographic photoreceptor 1 without being transferred is removed by the cleaning device 6.

After the transfer of the toner image onto the recording paper P, the recording paper P is made to pass through the fixing device 7 such that the toner image is thermally fixed onto the recording paper P, whereby obtaining a final image.

In addition to the above-described configuration, the image forming apparatus may be configured, for example, to be capable of carrying out a charge erase step. The charge erase step is a step of carrying out eliminating the charges by exposing the electrophotographic photoreceptor to light, and as a charge removal device, a fluorescent lamp or LED may, for example, be used. Further, regarding the intensity of the light used in the charge erase step, light having exposure energy at least three times the exposure light is frequently used. From the standpoints of miniaturization and energy conservation, the charge erase step is preferably omitted.

The image forming apparatus may further be modified such that the image forming apparatus is configured, for example, to be capable of carrying out a pre-exposure step or an auxiliary charging step, or to be capable of offset printing, or further may be configured as a full-color tandem system employing multiple kinds of toners.

In the invention, one or two or more of the charging device 2, the exposure device 3, the developing device 4, the transfer device 5, the cleaning device 6, and the fixing device 7 may be combined with the electrophotographic photoreceptor 1 to configure an integrated cartridge (hereinafter, referred as “electrophotographic photoreceptor cartridge” as appropriate) so that this electrophotographic photoreceptor cartridge can be mounted on and demounted from the main body of an electrophotographic apparatus such as a copier or a laser-beam printer.

### EXAMPLES

Hereinafter, embodiments of the present invention will be described more specifically with reference to examples. It is to be noted that the following examples are presented for the purpose of explaining the present invention in detail, and the present invention is not limited to the following examples, and can be arbitrarily modified and carried out within the scope not departing from the gist of the invention. In the following Examples and Comparative Examples, the term “parts” means “parts by mass” unless otherwise specified.

<Method for Measuring Viscosity-Average Molecular Weight of Resin>

First, method for measuring the viscosity-average molecular weight of the resin will be described. The resin to be measured is dissolved in dichloromethane to prepare a solution having a concentration C of 6.00 g/L. Using a Ubbelohde capillary viscometer having a solvent (dichloromethane) flow time t0 of 136.16 seconds, the sample solution is examined for flow time tin a thermostatic water bath set at 20.0° C. The viscosity-average molecular weight Mv is calculated according to the following equations.

a=0.438×ηnsp+1 ηsp=(t/t0)−1

b=100×ηsp/C C=6.00

η=b/a

Mv=3207×η1.205

<Production of Electrophotographic Photoreceptor>

### Example 1

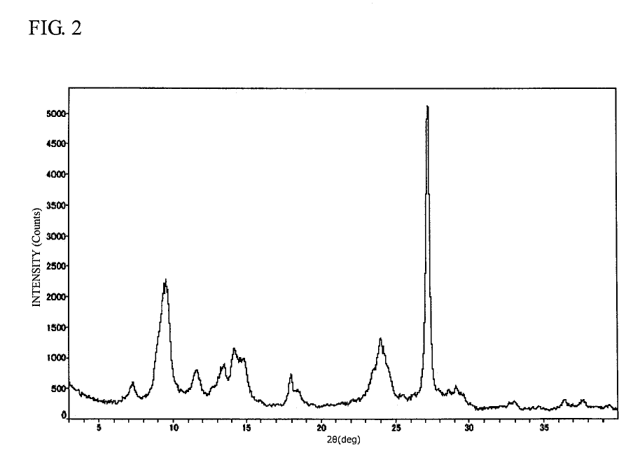

Ten parts by mass of oxytitanium phthalocyanine having a strong diffraction peak at Bragg angles (2θ±0.2) of 27.2° in the X-ray powder diffraction spectrum obtained with CuKα characteristic X-ray shown in FIG. 2 was mixed with 150 parts by mass of 1,2-dimethoxyethane. This mixture was subjected to a pulverization/dispersion treatment with a sand grinding mill, thereby obtaining a pigment dispersion. 160 parts by mass of the pigment dispersion thus obtained was mixed with 100 parts by mass of a 5 mass % 1,2-dimethoxyethane solution of polyvinyl butyral (trade name, #6000C; manufactured by Denki Kagaku Kogyo K.K.) and an appropriate amount of 4-methoxy-4-methyl-2-pentanone so as to prepare a coating fluid for undercoating with a solid content concentration of 4.0 mass %. A cylinder made of an aluminum alloy having an outer diameter of 30 mm, a length of 244 mm, and a thickness of 0.75 mm, the surface of which was machined, was dip coated with the coating fluid for undercoating to form an undercoat layer. The thickness of the obtained undercoat layer after drying was found to be 0.4 μm.

Next, 4.0 parts by mass of X-form metal-free phthalocyanine was dispersed in 60 parts by mass of toluene with a sand grinding mill. Meanwhile, 70 parts by mass of a hole transport material represented by Structural Formula (HTM-1), 40 parts by mass of an electron transport material represented by Structural Formula (ETM-1), 20 parts by mass of a compound represented by Structural Formula (AD-1), and 100 parts by mass of a polycarbonate resin represented by Structural Formula (P-1) [viscosity-average molecular weight: Mv=39,600] were dissolved in a mixed solvent of 590 parts by mass of tetrahydrofuran and 90 parts by mass of toluene, and 0.05 parts by mass of silicone oil was added thereto as a leveling agent. Into this, the above-described dispersion was further added, and the mixture thus obtained was uniformly mixed with a homogenizer so as to obtain a coating fluid for single-layer type photosensitive layer. The coating fluid for single-layer type photosensitive layer prepared as such was applied onto the undercoat layer to form a film having a thickness of 25 μm after drying, whereby obtaining Photoreceptor A which is a single-layer type electrophotographic photoreceptor for positive charging.

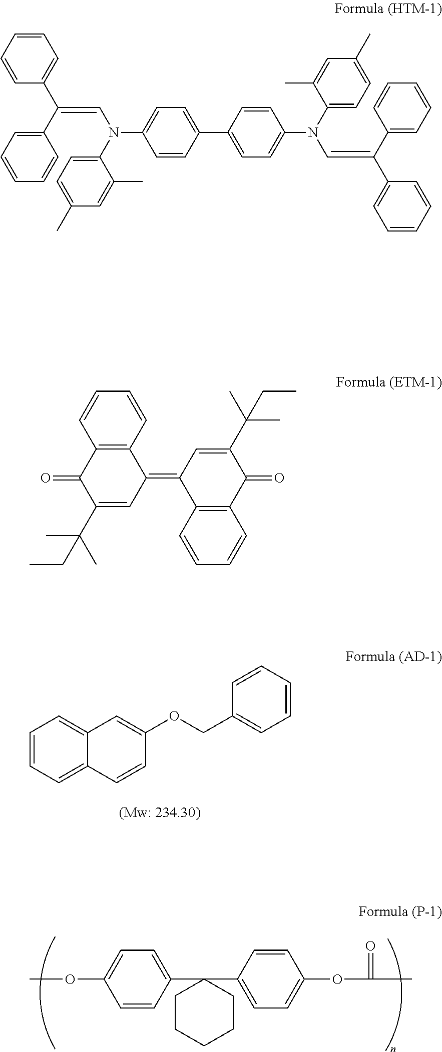

### Example 2

Photoreceptor B was produced in the same manner as in Example 1 except that the use amount of the compound represented by Formula (AD-1) was changed to 15 parts by mass.

### Example 3

Photoreceptor C was produced in the same manner as in Example 1 except that the use amount of the compound represented by Formula (AD-1) was changed to 10 parts by mass.

### Example 4

Photoreceptor D was produced in the same manner as in Example 1 except that the compound represented by Formula (AD-1) was replaced with a compound represented by Formula (AD-2).

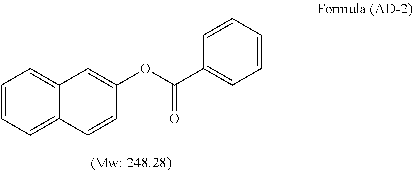 [SMILES: O=C(Oc1ccc2ccccc2c1)c1ccccc1]

### Example 5

Photoreceptor E was produced in the same manner as in Example 1 except that the compound represented by Formula (AD-1) was replaced with a compound represented by Formula (AD-3).

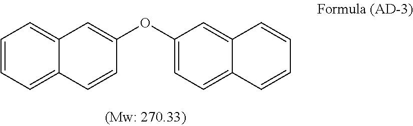 [SMILES: c1ccc2cc(Oc3ccc4ccccc4c3)ccc2c1]

### Example 6

Photoreceptor F was produced in the same manner as in Example 1 except that the compound represented by Formula (AD-1) was replaced with a compound represented by Formula (AD-4).

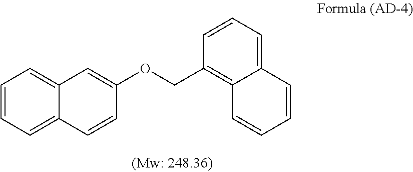 [SMILES: c1ccc2cc(OCc3cccc4ccccc34)ccc2c1]

### Comparative Example 1

Comparative photoreceptor A was produced in the same manner as in Example 1 except that the compound represented by Formula (AD-1) was not used.

### Comparative Example 2

Comparative photoreceptor B was produced in the same manner as in Example 1 except that the compound represented by Formula (AD-1) was replaced with 8 parts by mass of a compound represented by Formula (AD-5).

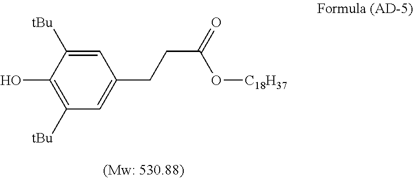

### Comparative Example 3

Comparative photoreceptor C was produced in the same manner as in Example 1 except that the compound represented by Formula (AD-1) was replaced with 2 parts by mass of a compound represented by Formula (AD-6).

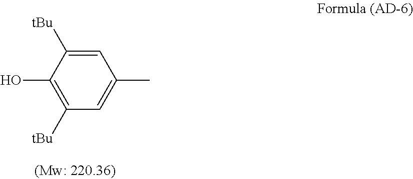 [SMILES: Cc1cc(C(C)(C)C)c(O)c(C(C)(C)C)c1]

### Comparative Example 4

Comparative photoreceptor D was produced in the same manner as in Example 1 except that the compound represented by Formula (AD-1) was replaced with 20 parts by mass of a compound represented by Formula (AD-7).

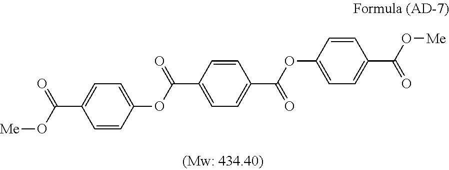 [SMILES: COC(=O)c1ccc(OC(=O)c2ccc(C(=O)Oc3ccc(C(=O)OC)cc3)cc2)cc1]

### Comparative Example 5

Comparative photoreceptor E was produced in the same manner as in Example 1 except that the compound represented by Formula (ETM-1) was replaced with a compound represented by Formula (ETM-2).

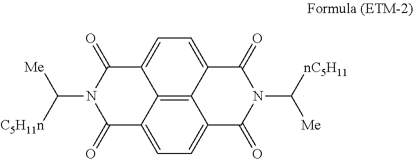

<Memory Evaluation Test>

Each of the electrophotographic photoreceptors obtained in Examples 1 to 6 and Comparative Examples 1 to 3 was mounted in a drum cartridge for A4 monochrome printer [HL 5240 (printing speed: monochrome 24 rpm, resolution: 1200 dpi, exposure source: laser, charging system: scorotron) manufactured by Brother Industries, Ltd.], and the drum cartridge was set in the above printer.

As a print input, a pattern having a bold text on a white background at the upper portion of the A4 area and having a half tone portion from the bold text printing portion to a lower portion of the A4 area had been sent from a personal computer to the printer, and the resultant output image was visually evaluated.

The printer used in the test does not perform photo-static charge elimination process. Thus, depending on the performance of the photoreceptor, there are cases in which the upper portion text pattern is memorized as a memory on the photoreceptor, which affects image formation of the next rotation. That is, there are cases in which the text pattern appears in the half tone portion as a memory image. Regarding a portion that was naturally expected to have a completely homogenous image density, the extent to which the memory image was visible was evaluated in 5 ranks based on visual observation results, with rank 1 being the least visible memory image and rank 5 being the most clearly observed memory image. The evaluation results are shown in Table-1.

<Producing Method of Sheet-Shaped Photoreceptor for Ozone Resistance Evaluation>

Except that each of the supports of a cylinder made of an aluminum alloy was replaced with a conductive support obtained by forming a vapor-deposited aluminum film (thickness: 70 nm) on the surface of a biaxially-oriented polyethylene terephthalate resin film (thickness: 75 μm), sheet-shaped photoreceptors for ozone resistance evaluation corresponding to Examples 1 to 6 and Comparative Examples 1 to 5 were produced in the same manner as in Examples 1 to 5 and Comparative Examples 1 to 6 by coating the supports thereof with the same coating fluids as used in Examples 1 to 6 and Comparative Examples 1 to 5 and drying the coating fluids so as to form photosensitive layers thereon having the same layer structures and film thicknesses as those of Examples 1 to 6 and Comparative Examples 1 to 5.

<Ozone Resistance Evaluation Test>

A method of performing ozone resistance evaluation test is described below. Using EPA 8200 manufactured by Kawaguchi Denki Co., Ltd., sheet-shaped photoreceptors obtained in accordance with the producing method of the sheet-shaped photoreceptor for ozone resistance evaluation were charged by applying a current of 25 μA to a corotron charger, and the charge values of the photoreceptors were defined as V1. Thereafter, the photoreceptors were exposed to ozone having a concentration of 300 ppm for 2 hours, and the charge values after exposure were measured in the same manner, and the charge values of the photoreceptors were defined as V2. Using the charge value V1 before exposure to ozone and the charge value V2 after exposure to ozone obtained in the above measurement, charge holding ratios (V2/V1×100) (%) before and after exposure to ozone were calculated, and the evaluation of the photoreceptors was carried out according to the following criteria. The evaluation results are shown in Table-1.

A: Charge holding ratio=65% or higher

B: Charge holding ratio=55% or higher and lower than 65%

C: Charge holding ratio=40% or higher and lower than 55%

D: Charge holding ratio=lower than 40%

TABLE 1

| | | Aromatic | Amount | | Ozone | Memory | |
|---|---|---|---|---|---|---|---|
| | Photoreceptor | compound | (by parts) | ETM | resistance | evaluation | Remarks |
| Example 1 | Photoreceptor A | AD-1 | 20 | ETM-1 | A | 1 | |
| Example 2 | Photoreceptor B | AD-1 | 15 | ETM-1 | A | 1 | |
| Example 3 | Photoreceptor C | AD-1 | 10 | ETM-1 | B | 2 | |
| Example 4 | Photoreceptor D | AD-2 | 20 | ETM-1 | A | 2 | |
| Example 5 | Photoreceptor E | AD-3 | 20 | ETM-1 | B | 2 | |
| Example 6 | Photoreceptor F | AD-4 | 20 | ETM-1 | B | 2 | |
| Comparative | Comparative | None | 0 | ETM-1 | D | 5 | Uneven image |
| Example 1 | Photoreceptor A | | | | | | density |
| Comparative | Comparative | AD-5 | 8 | ETM-1 | B | 4 | |
| Example 2 | Photoreceptor B | | | | | | |
| Comparative | Comparative | AD-6 | 2 | ETM-1 | A | 4 | |
| Example 3 | Photoreceptor C | | | | | | |
| Comparative | Comparative | AD-7 | 20 | ETM-1 | D | — | Cannot evaluate |
| Example 4 | Photoreceptor D | | | | | | because image |
| | | | | | | | density is too low |
| Comparative | Comparative | AD-1 | 20 | ETM-2 | C | 5 | |
| Example 5 | Photoreceptor E | | | | | | |

From the above results, it has been confirmed that according to the present invention, it is possible to obtain a single-layer type electrophotographic photoreceptor for positive charging that is stable with less decrease in initial charging properties and has favorable initial memory under ozone exposure while retaining the electrical properties, and an image forming apparatus and a cartridge that each include the photoreceptor and with which an image having satisfactory image density can be formed.

Although description regarding the present invention has been provided in detail using specific embodiments, it will be apparent to those skilled in the art that various modifications and variations are possible without departing from the spirit and scope of the invention. This application is based on a Japanese patent application (Japanese Patent Application No. 2015-050946) filed on Mar. 13, 2015, the entirety of which is incorporated herein by reference.

1. A single-layer type electrophotographic photoreceptor for positive charging, the photoreceptor comprising:
a conductive support; and
a photosensitive layer disposed on the conductive support, the photosensitive layer including a binder resin, a charge generation material, a hole transport material, and an electron transport material within the same layer,
wherein the electron transport material is a compound represented by Formula (1), and
the photosensitive layer contains an aromatic compound represented by Formula (7) and having a molecular weight of 180 to 400: 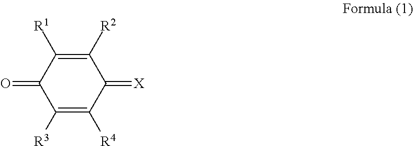
[in Formula (1), R¹ to R⁴ each independently represent a hydrogen atom, an alkyl group having 1 to 20 carbon atoms that may have a substituent, or an alkenyl group having 1 to 20 carbon atoms that may have a substituent, R¹ and R², or R³ and R⁴ may be bonded to each other to form a cyclic structure, and X represents an organic residue having a molecular weight of 120 to 250] 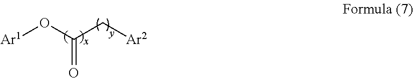
[in Formula (7), Ar¹ and Ar² each independently represent an aryl group that may have a substituent, and x and y each independently represent an integer of 0 to 2].

2. The single-layer type electrophotographic photoreceptor for positive charging according to claim 1,
wherein the content of the aromatic compound represented by Formula (7) in the photosensitive layer is 1 part by mass to 50 parts by mass with respect to 100 parts by mass of the binder resin.

3. The single-layer type electrophotographic photoreceptor for positive charging according to claim 1,
wherein the charge generation material is a phthalocyanine pigment.

4. The single-layer type electrophotographic photoreceptor for positive charging according to claim 1,
wherein the binder resin is a polycarbonate resin.

5. The single-layer type electrophotographic photoreceptor for positive charging according to claim 1,
wherein in Formula (1), X is an organic residue represented by any one of Formulae (3) to (6): 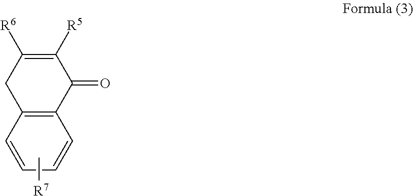
[in Formula (3), R⁵ to R⁷ each independently represent a hydrogen atom or an alkyl group having 1 to 6 carbon atoms] 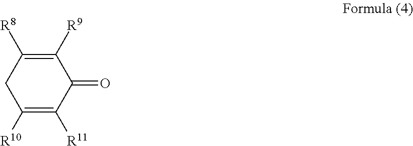
[in Formula (4), R⁸ to R¹¹ each independently represent a hydrogen atom, halogen atom, or an alkyl group having 1 to 6 carbon atoms] 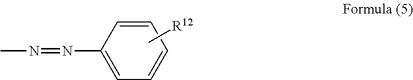
[in Formula (5), R¹² represents a hydrogen atom, an alkyl group having 1 to 6 carbon atoms, or a halogen atom] 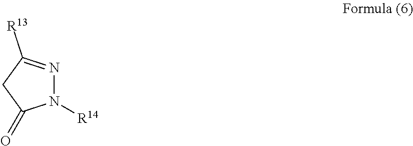
[in Formula (6), R¹³ and R¹⁴ each independently represent a hydrogen atom, an alkyl group having 1 to 6 carbon atoms, or an aryl group having 6 to 12 carbon atoms].

6. An electrophotographic photoreceptor cartridge, comprising:
the single-layer type electrophotographic photoreceptor for positive charging according to claim 1; and
at least one selected from the group consisting of a charging device for charging the electrophotographic photoreceptor, an exposure device for exposing the charged electrophotographic photoreceptor so as to form an electrostatic latent image thereon, and a developing device for developing the electrostatic latent image formed on the electrophotographic photoreceptor.

7. An image forming apparatus comprising:
the single-layer type electrophotographic photoreceptor for positive charging according to claim 1;
a charging device for charging the electrophotographic photoreceptor;
an exposure device for exposing the charged electrophotographic photoreceptor to light so as to form an electrostatic latent image thereon; and
a developing device for developing the electrostatic latent image formed on the electrophotographic photoreceptor.

8. The image forming apparatus according to claim 7, which does not provide light for charge erase.

9. The single-layer type electrophotographic photoreceptor for positive charging according to claim 1, which is used in an electrophotographic process which does not provide light for charge erase.
